(19) United States
(12) Patent Application Publication
(10) Pub. No.: US 2013/0173875 A1
(43) Pub. Date: Jul. 4, 2013

(54) METHOD OF MANAGING STORAGE REGION OF MEMORY DEVICE, AND STORAGE APPARATUS USING THE METHOD

(71) Applicant: SAMSUNG ELECTRONICS CO., LTD., Suwon-Si (KR)

(72) Inventors: Kyung-ho KIM, Seoul (KR); Sang-mok KIM, Seoul (KR); Hyun-chul PARK, Ansan-si (KR); O-tae BAE, Daegu (KR)

(73) Assignee: SAMSUNG ELECTRONICS CO., LTD., Suwon-Si (KR)

(21) Appl. No.: 13/716,727

(22) Filed: Dec. 17, 2012

(30) Foreign Application Priority Data
Dec. 28, 2011 (KR) 10-2011-0145016

(51) Int. Cl. G06F 12/12

(52) U.S. Cl. CPC G06F 12/122
USPC 711/160

(57) ABSTRACT

A method of managing a storage region of a memory device, and a storage apparatus using the method. In the method, data blocks are arranged in an order of performing writing on the memory device; a frequency of updating data in a logical page to be written is determined, based on whether an invalid physical page is present in a block within a window size that is initially set based on a most recently written data block from among the arranged data blocks, in response to a write request, and the data in the logical page is stored in a storage region of the memory device classified according to the determined frequency, according to the determined frequency.

### CROSS-REFERENCE TO RELATED APPLICATIONS

This application claims the benefit of Korean Patent Application No. 10-2011-0145016, filed on Dec. 28, 2011, in the Korean Intellectual Property Office, the disclosure of which is incorporated herein in its entirety by reference.

### BACKGROUND

Example embodiments of the inventive concepts relate to storage apparatuses, and more particularly, to a method of managing a storage region of a memory device and/or a storage apparatus using the method.

Nonvolatile memory devices are capable of retaining information stored therein even when a power off occurs. An example of a nonvolatile memory device is a flash memory. There is a need to develop a technique of efficiently analyzing a use pattern of data stored in a nonvolatile memory device in a storage apparatus so as to minimize a write cost or a garbage collection cost.

### SUMMARY

Some example embodiments of inventive concepts provide a method of determining a storage region of a memory device, in which a frequency of updating data in a logical page is determined to minimize use of memory resources and a storage region of the memory device is determined according to the determined frequency.

Some example embodiments of the inventive concepts also provide a storage apparatus for determining a frequency to updating data in a logical page to minimize use of memory resources, and determining a storage region of a memory device according to the determined frequency.

According to an example embodiment of the inventive concepts, there is provided a method of managing a storage region of a memory device, the method including arranging data blocks in an order of performing writing on the memory device; determining a frequency of updating data in a logical page to be written in response to a write request, the determining being based on whether an invalid physical page is present in a block within a window size, the window size being initially set based on a most recently written data block from among the arranged data blocks; and storing the data in the logical page in a storage region of the memory device classified according to the determined frequency.

A location of the invalid physical page may be determined to be an address of a valid physical page mapped to an address of the logical page to be written.

If no invalid physical page is present, the logical page may be classified as a cold page, in response to the write request.

The physical page to be written may be determined to be a hot page if an invalid physical page is present in a data block within the window size, and be classified as a cold page if an invalid physical page is not present in a data block within the window size.

The logical page determined as the hot page may be allocated to a physical page included in an active block that is set as a hot active block, and the logical page determined as the cold page may be allocated to a physical page included in an active block that is set as a cold active block.

If data is completely stored in all pages included in the active block that is set as the hot active block or the cold active block, the active block may be moved to a data block.

If the hot active block or the cold active block is moved to a data block, a block sequence number allocated to the data block may be increased by ‘1’.

The data blocks may be arranged in the order of performing writing on the memory device, based on the block sequence number.

During the arranging of the data blocks, data blocks generated through garbage collection may be excluded from the data blocks.

The window size may vary according to workload characteristics.

The window size may be determined to be a window size that is expected to have a least write cost, based on a write cost calculated based on a number of invalid pages in the data blocks arranged in the order of performing writing.

Selecting, if a hot data block that does not fall within the window size is present, the hot data block to be a victim data block to perform garbage collection. Selecting a data block having a largest number of invalid pages from among data blocks that do not fall within the window size may be selected to be a victim data block to perform garbage collection if a hot data block that does not fall within the window size is not present.

According to another example embodiment of the inventive concepts, there is provided a storage apparatus including a memory device configured to store data; and a memory controller configured to generate block sequence information based on an order of performing writing on the memory device; configured to determine a frequency of updating data in a logical page to be written based on the block sequence information and the mapping table information, the determining being based on whether an address of a valid physical page mapped to an address of the logical page is present in a block within a window size, the window size being initially set based on a most recently written block from among data blocks arranged based on the block sequence information; and the memory controller configured to allocate a physical page address to the logical page.

The memory controller may include a volatile memory device configured to temporarily store the block sequence information and the mapping table information; and a control unit configured to determine the logical page to be a hot page if an address of a physical page mapped to the address of the logical page is present in a block within the window size, configured to determine the logical page to be a cold page if an address of a physical page mapped to the address of the logical page is not present in a block within the window size, based on the mapping table information and the block sequence information, and configured to control page writing by separating a hot page storage region and a cold page storage region from each other.

The control unit may include firmware configured to perform garbage collection by determining a hot data block that does not fall within the window size to be a victim data block if the hot data block is present and determining a data block having a least garbage collection cost from among data blocks that do not fall within the window size, to be a victim data block if the hot data block is not present.

According to another example embodiment of the inventive concepts, there is provided a method of managing data blocks in a memory device, the method including storing data from a logical page in a first type of data block if an address of the logical page is mapped to an address of a physical page in a data block determined to be in a window size W, the window size W based on a most recently written data block from among data blocks arranged based on block sequence numbers; and storing the data from the logical page in a second type of data block if one of (1) the address of the logical page is not mapped to an address of a physical page and (2) if the address of the logical page is mapped to an address of a physical page in a data block outside the window size W.

The window size is set to have a least write cost, based on a write cost calculated based on a number of invalid pages in the data blocks arranged in the order of performing writing.

Selecting, if a hot data block that does not fall within the window size is present, the hot data block to be a victim data block to perform garbage collection, and selecting a data block having a largest number of invalid pages from among data blocks that do not fall within the window size is selected to be a victim data block to perform garbage collection if a hot data block that does not fall within the window size is not present.

### BRIEF DESCRIPTION OF THE DRAWINGS

Example embodiments of the inventive concepts will be more clearly understood from the following detailed description taken in conjunction with the accompanying drawings in which:

FIG. 1 is a block diagram of a data storage system according to an example embodiment of the inventive concepts;

FIG. 2 is a detailed block diagram of a host device illustrated in FIG. 1, according to an example embodiment of the inventive concepts;

FIG. 3 is a detailed block diagram of a memory controller illustrated in FIG. 1, according to an example embodiment of the inventive concepts;

FIG. 4 is a diagram illustrating a structure of a storage region of a memory device of FIG. 1, according to an example embodiment of the inventive concepts;

FIG. 5 is a detailed block diagram of the memory device of FIG. 1, according to an example embodiment of the inventive concepts;

FIG. 6 is a conceptual diagram illustrating an internal storage structure of a flash memory, according to an example embodiment of the inventive concepts;

FIG. 7 is a diagram illustrating a software structure of a data storage system, according to an example embodiment of the inventive concepts;

FIG. 8A is a graph showing the total number of invalid pages of each block when a random workload is run on a flash memory;

FIG. 8B is a graph showing the total number of invalid pages of each block when a hot workload is run on a flash memory;

FIG. 9 is a conceptual diagram illustrating the relationship between blocks, for explaining hot/cold page separation, according to an example embodiment of the inventive concepts:

FIG. 10 illustrates data blocks arranged to analyze the number of hot/cold pages in blocks within a window when a window size to be predicted is greater than a currently set window size, according to an example embodiment of the inventive concepts;

FIG. 11 illustrates data blocks arranged to analyze the number of hot/cold pages in blocks within a window when a window size to be predicted is less than a currently set window size, according to an example embodiment of the inventive concepts;

FIG. 12 is a graph showing the relationship between an overprovision and an average garbage collection cost in a storage apparatus, according to an example embodiment of the inventive concepts;

FIG. 13 is a graph showing the relationship between an overprovision and an average garbage collection cost in a storage apparatus, according to another example embodiment of the inventive concepts;

FIG. 14 is a graph comparing minimum write amplitude factor (WAF) values calculated with respect to random data by using a model according to a window size according to an example embodiment of the inventive concepts with WAF values that were actually measured;

FIG. 15 is a graph comparing WAF values calculated using a model according to an example embodiment of the inventive concepts with WAF values that were actually measured, when a ratio between amounts of hot writing and cold writing is 1:2 and a workload is an A type workload with a hot data region of 7 MB (1/200);

FIG. 16 is a graph comparing WAF values calculated using a model according to an example embodiment of the inventive concepts with WAF values that were actually measured, if a ratio between amounts of hot writing and cold writing is 2:1 and a workload is a B type workload with a hot data region of 4 MB (1/100);

FIG. 17 is a flowchart illustrating a method of managing a storage region of a memory device, according to an example embodiment of the inventive concepts;

FIG. 18 is a detailed flowchart of an operation S120 included in the method of FIG. 17, according to an example embodiment of the inventive concepts;

FIG. 19 is a detailed flowchart of an operation S130 included in the method of FIG. 17, according to an example embodiment of the inventive concepts;

FIG. 20 is a flowchart illustrating a method of performing garbage collection, according to an example embodiment of the inventive concepts;

FIG. 21 is a detailed flowchart of an operation S420 included in the method of FIG. 20, according to an example embodiment of the inventive concepts;

FIG. 22A is a graph illustrating WAF values calculated by applying a dynamic data clustering (DAC)-Level 4 method to various workloads;

FIG. 22B is a graph illustrating WAF values calculated by applying a DAC-Level 2 method to various workloads;

FIG. 22C is a graph illustrating WAF values calculated by applying hot/cold page separation method according to an example embodiment of the inventive concepts to various workloads;

FIG. 23 is a block diagram of a computer system according to an example embodiment of the inventive concepts;

FIG. 24 is a block diagram of a memory card according to an example embodiment of the inventive concepts; and

FIG. 25 is a block diagram of a network system that includes a data storage system, according to an example embodiment of the inventive concepts.

### DETAILED DESCRIPTION OF EXAMPLE EMBODIMENTS

Hereinafter, example embodiments of the inventive concepts will be described more fully with reference to the accompanying drawings, in which some example embodiments are shown. These example embodiments are provided so that this disclosure will be thorough and complete, and will fully convey the scope of example embodiments of the inventive concepts to those of ordinary skill in the art. Example embodiments of the inventive concept may, however, be embodied in many different forms and should not be construed as limited to the example embodiments set forth herein. It would be obvious to those of ordinary skill in the art that the above example embodiments are to cover all modifications, equivalents, and alternatives falling within the scope of the inventive concepts. Like reference numerals denote like elements throughout the drawings. In the drawings, the lengths and sizes of layers and regions may be exaggerated for clarity.

The terminology used herein is for the purpose of describing particular embodiments only and is not intended to be limiting of the invention. As used herein, the singular forms ‘a’, “an”, and “the” are intended to include the plural forms as well, unless the context clearly indicates otherwise. It will be further understood that the terms ‘comprise,’ ‘comprises,’ ‘include’ ‘includes’ and/or ‘has’, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a block diagram of a data storage system 100 according to an example embodiment of the inventive concepts. Referring to FIG. 1, the data storage system 100 includes a host device 110 and a storage apparatus 120.

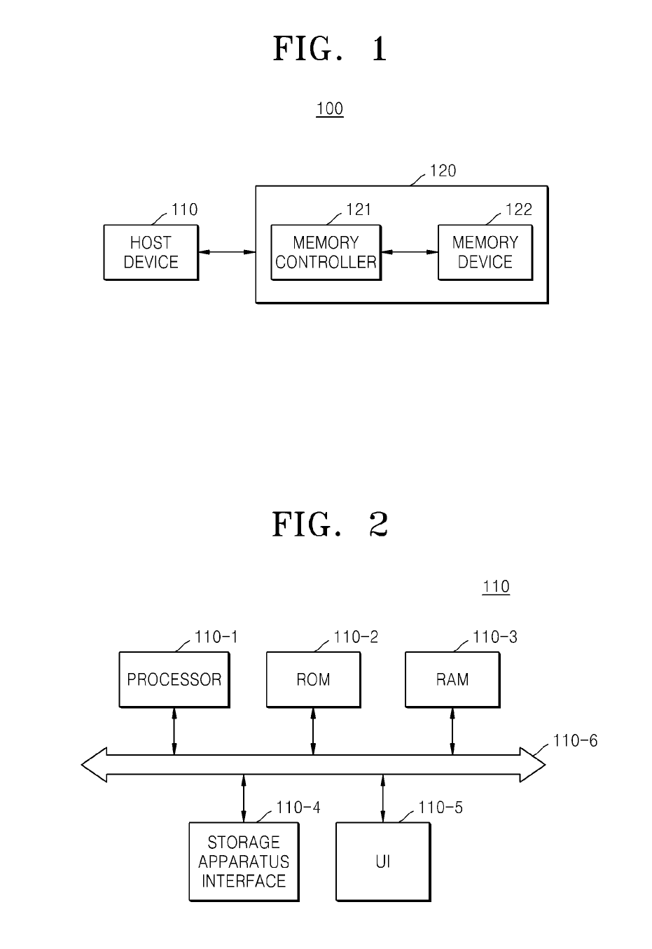

A detailed structure of the host device 110 is illustrated in FIG. 2.

Referring to FIG. 2, the host device 110 includes a processor 110-1, a read only memory (ROM) 110-2, a random access memory (RAM) 110-3, a storage apparatus interface 110-4, a user interface (UI) 110-5, and a bus 110-6.

The bus 110-6 is a transmission path via which data is exchanged between the elements of the host device 110.

The ROM 110-2 stores various application programs supporting storage protocols, e.g., an advanced technology attachment (ATA), a small computer system interface (SCSI), an embedded multi-media card (eMMC), and a unix file system (UFS).

The RAM 110-3 temporarily stores data or programs.

The UI 110-5 is a physical or virtual medium via which information is exchanged among, for example, a user, the host device 110, and a computer program, and includes physical hardware and logical software. The UI 110-5 may include an input device via which a user may manipulate the host device 110, and an output device that displays a result of processing a user input.

The processor 110-1 controls overall operations of the host device 110. The processor 110-1 may control a command for storing data in or reading data from the storage apparatus 120 to be generated using an application or a tool stored in the ROM 110-2 and to be transmitted to the storage apparatus 120 via the storage apparatus interface 110-4.

The storage apparatus interface 110-4 may be an interface supporting storage protocols, such as, an ATA interface, a serial advanced technology attachment (SATA) interface, a parallel advanced technology attachment (PATA) interface, a universal serial bus (USB), a serial attached small computer system (SAS) interface, an SCSI, an eMMC interface, or a UFS interface.

Referring back to FIG. 1, the storage apparatus 120 includes a memory controller 121 and a memory device 122.

If the memory device 122 is embodied as a non-volatile semiconductor memory, for example, a flash memory, then the storage apparatus 120 may be a solid state drive (SSD). The memory controller 121 controls erasing, writing, or reading to be performed on the memory device 122 according to a command received from the host device 110.

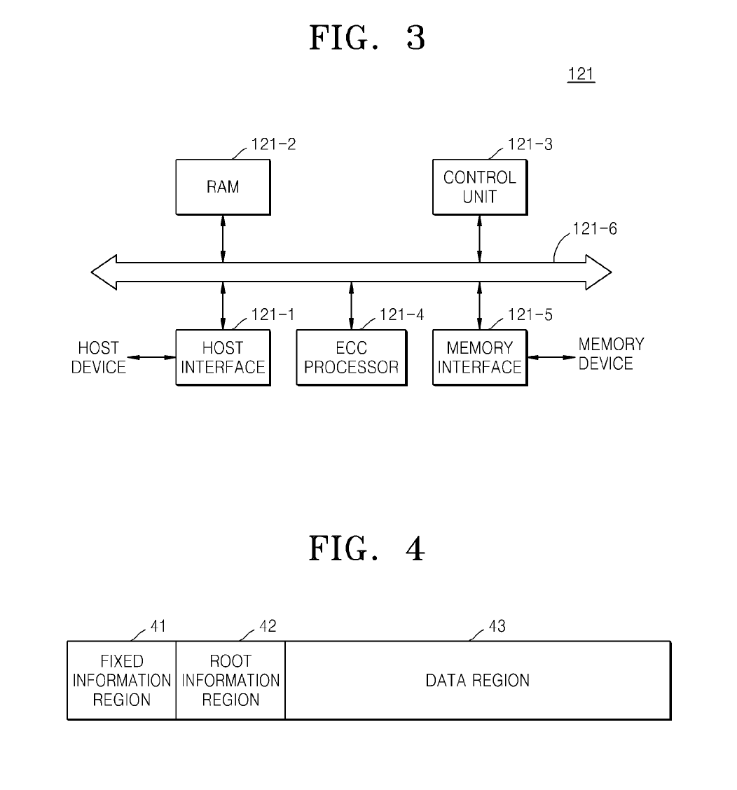

A detailed structure of the memory controller 121 is illustrated in FIG. 3.

Referring to FIG. 3, the memory controller 121 includes a host interface 121-1, a RAM 121-2, a control unit 121-3, an error correction code (ECC) processor 121-4, a memory interface 121-5, and a bus 121-6.

The bus 121-6 is a transmission path via which data is exchanged between the elements of the memory controller 121.

The control unit 121-3 controls overall operations of the storage apparatus 120. In particular, the control unit 121-3 interprets a command received from the host device 110 of FIG. 1, and controls the storage apparatus 120 to perform an operation according to a result of the interpreting.

The host interface 121-1 includes a data exchange protocol between the storage apparatus 120 and the host device 110 connected to the storage apparatus 120, and connects the storage apparatus 120 and the host device 110. The host interface 121-1 may be embodied as an ATA interface, an SATA interface, a PATA interface, a USB, an SAS interface, an SCSI, an eMMC interface, or a UFS interface, but is not limited thereto. Specifically, the host interface 121-1 exchanges a command, an address, and data with the host device 110 under control of the control unit 121-3.

The RAM 121-2 temporarily stores data received from the host device 110, data generated by the control unit 121-3, or data read from the memory device 122. The RAM 121-2 further stores meta data read from the memory device 122. The RAM 121-2 may be embodied as a dynamic random access memory (DRAM) or a static SRAM.

The meta data is generated by the storage apparatus 120 to manage the memory device 122. The meta data which is management information includes mapping table information for translating a logical address to a physical address of the memory device 122. For example, the meta data may include page mapping table information for performing address mapping in units of pages. The meta data may further include block sequence information assigned to blocks according to an order of writing to be performed on the memory device 122. The meta data may further include information for managing a storage region of the memory device 122.

In a write operation, the ECC processor 121-4 may generate an error correction code for received data, based on an algorithm, such as, Reed-Solomon (RS) code, Hamming code, or cyclic redundancy code (CRC). In a read operation, an error may be detected in data and then be corrected by using the ECC read together with the data.

The memory interface 121-5 is electrically connected to the memory device 122. The memory interface 121-5 exchanges a command, an address, or data with the memory device 122 under control of the control unit 121-3. The memory interface 121-5 may be constructed to support an AND or NOR flash memory. The memory interface 121-5 may be constructed to selectively perform software/hardware interleaved operations via a plurality of channels.

The control unit 121-3 provides a read command and an address to the memory device 122 during a read operation, and provides a write command, an address, and data to the memory device 122 in a write operation. The control unit 121-3 translates a logical address received from the host device 110 to a physical address, based on meta data stored in the RAM 121-2.

When power is supplied to the storage apparatus 120, the control unit 121-3 controls the storage apparatus 120 to read the meta data from the memory device 122 and store the meta data in the RAM 121-2. The control unit 121-3 controls the storage apparatus 120 to update the meta data stored in the RAM 121-2 when the memory device 122 performs an operation that causes a change to occur in the meta data. The control unit 121-3 controls the meta data stored in the RAM 121-2 to be written to the memory device 122 before the supply of power to the storage apparatus 120 is off.

The control unit 121-3 controls block sequence information to be generated based on the order of writing; determines a frequency of updating data in a logical page to be written according to whether the address of a valid physical page mapped to the address of the logical page is present in a block having a window size that is less than or equal to an initially set window size based on a most recently written block from among blocks arranged according to the block sequence information, based on the block sequence information and the mapping table information; and then controls a physical page address of the memory device 122 to be allocated to the logical page, based on the determined frequency.

The control unit 121-3 includes firmware for performing operations, such as page type analysis, meta data management, block sequence management, garbage collection processing, and parameter optimization, which will be described in detail below.

Referring back to FIG. 1, the memory device 122 may be embodied as a nonvolatile semiconductor memory device, such as, a flash memory, a phase-change RAM (PRAM), a ferroelectric RAM (FRAM), a magnetic RAM (MRAM), or the like.

Referring to FIG. 4, a storage region of the memory device 122 may be divided into a fixed information region 41, a root information region 42, and a data region 43.

The fixed information region 41 may store unique information about the memory device 122, for example, information and version of a file system, and the total number of pages per block. The data region 43 stores meta data and user data. The data region 43 may be divided into a meta data storage region and a user data region. The user data region may be divided into a data storage region and a spare region. The spare region may store ECCs.

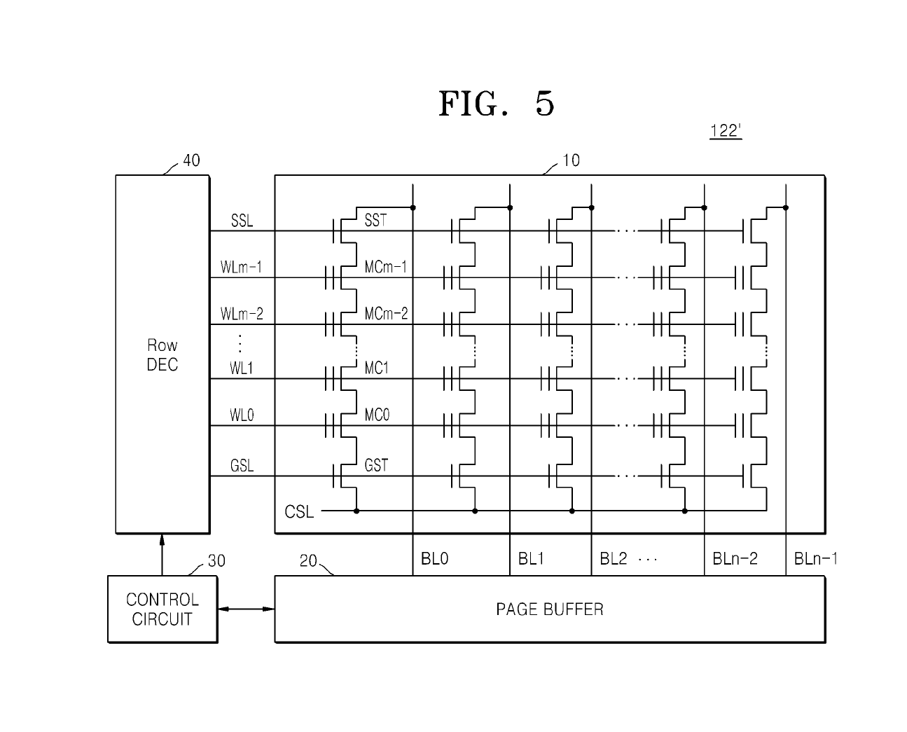

For example, a case where the memory device 122 is embodied as a flash memory is illustrated in FIG. 5.

Referring to FIG. 5, a flash memory 122′ includes a cell array 10, a page buffer 20, a control circuit 30 and a row decoder 40.

In the cell array 10, data is written by applying a voltage to a transistor therein. The cell array 10 includes memory cells formed at intersections of word lines WL0 to WLm−1 and bit lines BL1 to BLn−1. Here, ‘m’ and ‘n’ are each a natural number. Although FIG. 5 illustrates one memory block included in the cell array 10, the cell array 10 may include a plurality of memory blocks. Each of the plurality of memory blocks includes pages corresponding to the word lines WL0 to WLm−1. Each of the pages includes a plurality of memory cells connected to the corresponding word line from among the word lines WL0 to WLm−1. The flash memory 122′ performs erasing in units of blocks, and performs programming or reading in units of pages.

The memory cell array 10 has a cell string structure. Each of cell strings includes a string selection transistor SST connected to a string selection line (SSL), a plurality of memory cells MC0 to MCm−1 being respectively connected to the word lines WL0 to WLm−1, and a ground selection transistor GST connected to a ground selection line (GSL). The string selection transistor SST is connected between each of the bit lines BL0 to BLn−1 and a string channel. The ground selection transistor GST is connected between the string channel and a common source line (CSL).

The page buffer 20 is connected to the cell array 10 via the bit lines BL0 to BLn'1. The page buffer 20 temporarily stores data to be written to or to be read from memory cells connected to a selected word line.

The control circuit 30 generates various voltages for performing writing, reading, and erasing, and the control circuit 30 receives control signals and controls overall operations of the flash memory 122′.

The row decoder 40 is connected to the cell array 10 via the selection lines SSL and GSL and the word lines WL0 to WLm−1. The row decoder 20 receives an address during a write or read operation, and selects a word line from among the word lines WL0 to WLm−1 according to the received address. The selected word line is connected to memory cells to which writing or reading is to be performed.

Also, the row decoder 40 applies voltages for performing programming or reading to the selected word line, the other word lines, and the selection lines SSL and GSL, for example, a program voltage, a pass voltage, a read voltage, a string selection voltage, and a ground selection voltage.

Each of the memory cells may store 1-bit data or 2 or more bit data. A memory cell capable of storing 1-bit data is referred to as a single level cell (SLC), and a memory cell capable of storing 2 or more bit data is referred to as a multi level cell (MLC). The SLC has an erase state or a program state according to a threshold voltage.

If the reliability of a flash memory consisting of MLCs may be lowered due to factors such as a period of use and a program/erase cycle, ECC correction cannot be performed on the flash memory. In the flash memory, a spare region is present in a physical page and ECC information is stored in the spare region.

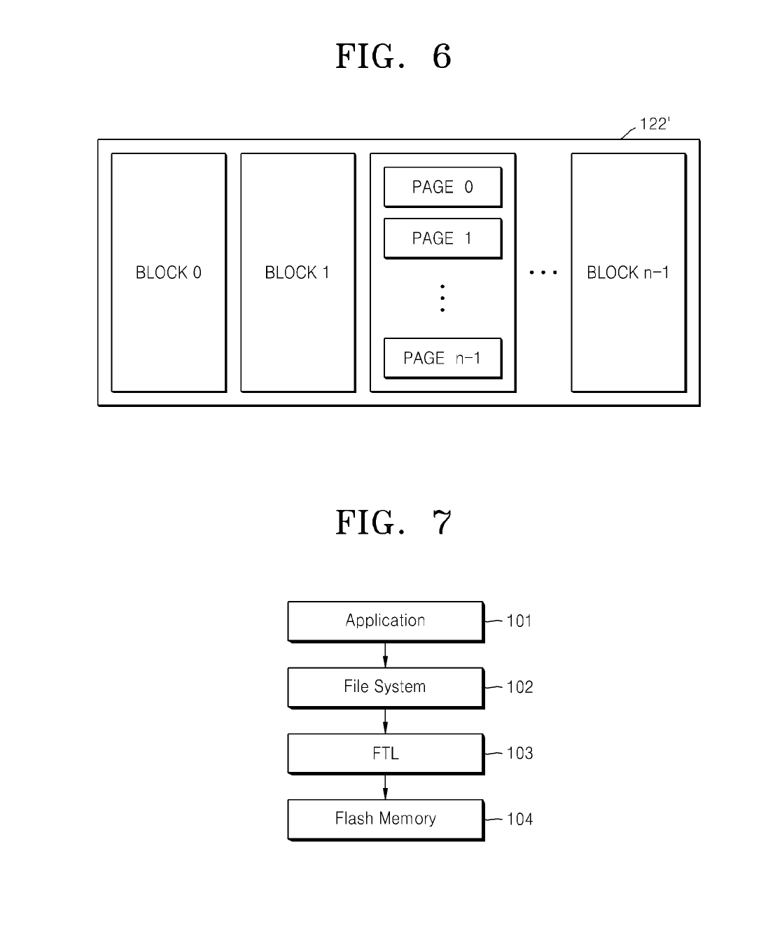

Referring to FIG. 6, the flash memory 122′ includes a plurality of blocks therein, and each of the plurality of blocks may consist of a plurality of pages.

In the flash memory 122′, writing and reading are performed in units of pages and electrical erasing is performed in units of blocks. Electrical erasing should be performed before writing is performed, and thus, overwriting is not permitted in the flash memory 122′.

In a memory device on which overwriting cannot be performed, user data cannot be written to a desired physical region thereof. Thus, when accessing of a region of the memory device is requested by a user to write data to or read data from the region, address translation is performed by assigning a logical address to this region and assigning a physical address to a physical region of the memory device in which the data is actually stored or is to be stored, thereby translating a logical address of the user data to a physical address.

A method of translating a logical address to a physical address, performed by the data storage system 100 of FIG. 1 will be described with reference to FIG. 7 below.

FIG. 7 is a diagram illustrating a software structure of the data storage system 100 of FIG. 1, according to an example embodiment of the inventive concepts. Specifically, FIG. 7 illustrates a software structure of the data storage system 100 if the memory device 122 included in the data storage system 100 is embodied as, for example, a flash memory.

Referring to FIG. 7, the data storage system 100 has a hierarchical software structure in which an application 101, a file system 102, a flash translation layer (FTL) 103, and a flash memory 104 are sequentially formed. The flash memory 104 may be the flash memory 122′ of FIGS. 5 and 6.

The application 101 is firmware for processing user data according to a user input received via the UI 110-5 of FIG. 2. For example, the application 101 may be document processing software, such as, a word processor, calculating software, or a document viewer, such as, a web browser. The application 101 transmits a command to the file system 102 for processing the user data according to the user input and storing the processed user data in the flash memory 104.

The file system 102 is a scheme or software for storing the user data in the flash memory 104. The file system 102 allocates a logical address at which the user data is to be stored, according to a command given from the application 101. Examples of the file system 102 include a file allocation table (FAT) file system and a new technology file system (NTFS).

In the FTL 103, the logical address received from the file system 102 is translated to a physical address for performing reading/writing on the flash memory 104. The FTL 103 translates the logical address to the physical address, based on mapping table information included in meta data. A page mapping method or a block mapping method may be used for address mapping. In the page mapping method, address mapping is performed in units of pages. In the block mapping method, address mapping is performed in units of blocks. Alternatively, a mixed mapping method that is a combination of the page mapping method and the block mapping method may be used. The physical address represents a location on the flash memory 104, in which data is stored.

The FTL 103 according to an example embodiment of the inventive concepts may determine a frequency of updating data in a logical page, and translate a logical page address to a physical page address so that the data may be stored in storage regions of the flash memory 104 that are divided according to the determined frequency.

The FTL 103 may perform address translation by using firmware installed in the control unit 121-3 of FIG. 3 as described below.

A basic concept of a method of determining a frequency of updating page data according to an example embodiment of the inventive concepts will be described.

The pattern of the total number of invalid pages of each block if data is randomly written to an entire region of the flash memory 104 is different from that when a frequency of writing data to a particular region of the flash memory 104 is high. The randomly writing of the data to the entire region of the flash memory 104 means that the written data is cold data. When the frequency of writing data to the particular region of the flash memory 104 is high, it means that hot data and cold data are intermixed.

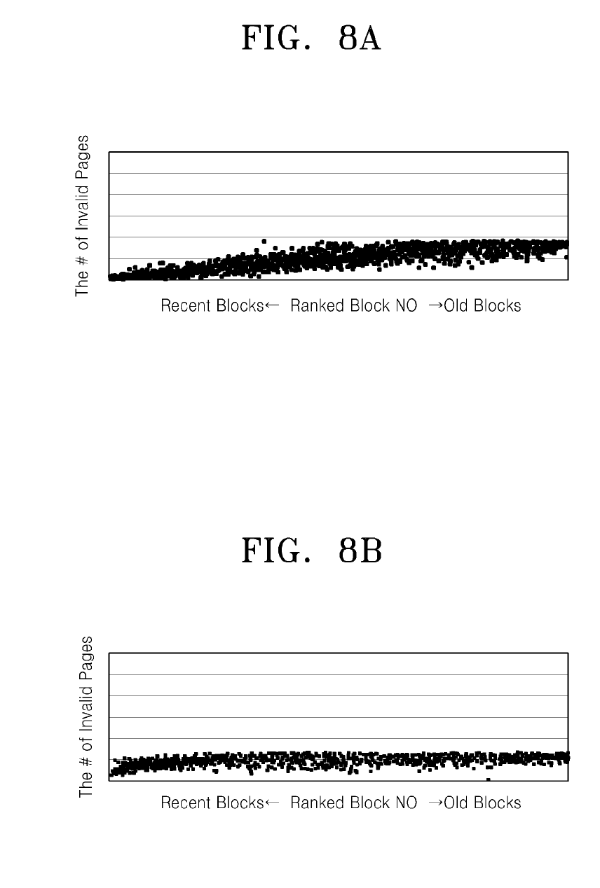

FIG. 8A is a graph showing the total number of invalid pages of each block when data is randomly written to an entire storage region of a flash memory. FIG. 8B is a graph showing the total number of invalid pages of each block when a frequency to written data to a particular region of the flash memory is high.

In FIGS. 8A and 8B, the X-axis denotes block numbers categorized based on points of time when writing is respectively performed on blocks, and the Y-axis denotes the total number of invalid pages for each of the blocks. The lower a block number, the more recent writing is performed on the block, and the higher the block number, the less recent writing is performed on the block.

Referring to FIG. 8A, as a block becomes older, the number of invalid pages increases linearly. Referring to FIG. 8B, when hot data is present, the number of invalid pages sharply increases and then gently increases in a most recently written block.

According to an example embodiment of the inventive concepts, hot data and cold data are separated from each other, considering that the pattern of the number of invalid pages included in each block in the case of a random workload is different than in the case of a workload that includes hot data.

Since the number of invalid pages in the entire blocks is regular, the number of invalid pages in a victim block that includes random data is less than the number of invalid pages in a victim block that includes hot data. Thus, a garbage collection cost of the random data is greater than that of the hot data.

The hot data may be defined as data that is written to a particular region, and the cold data may be defined as data that is randomly written to entire regions.

Referring to FIG. 6, a storage region of a flash memory is divided into blocks, and each of the blocks consists of a plurality of pages.

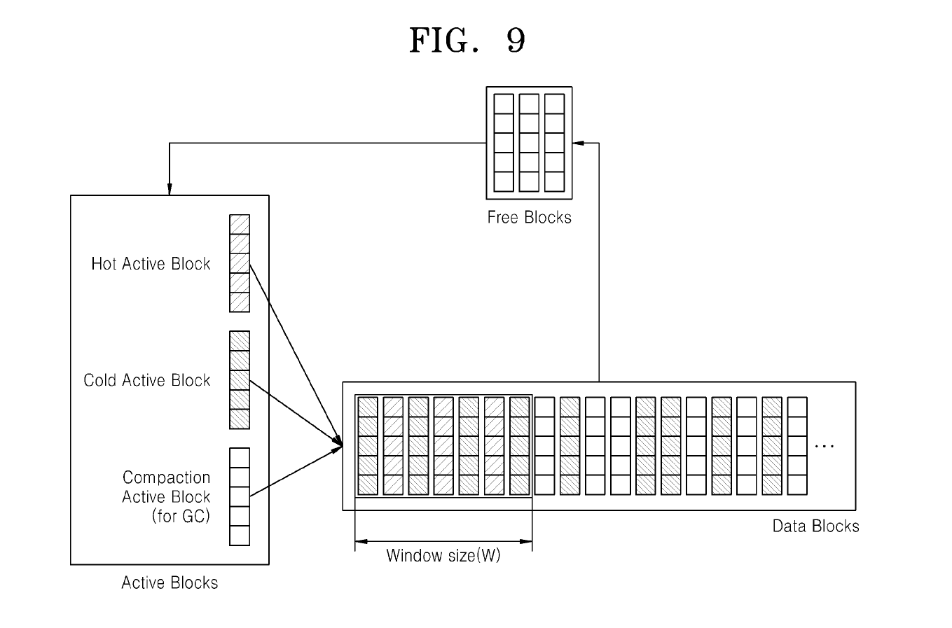

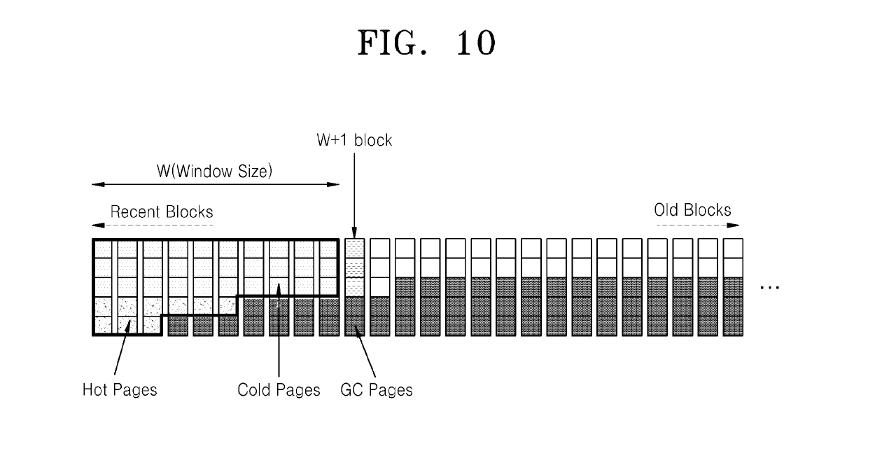

Referring to FIG. 9, blocks of a flash memory are categorized into free blocks, active blocks, and data blocks. The free blocks indicate blank blocks. The active blocks indicate blocks in which data has been stored and new data may further be written to. The data blocks mean blocks in which data has been stored and new data may further be written to. In other words, the data blocks do not have empty pages to which data may be written.

The active blocks may be categorized into a hot active block, a cold active block, and a compaction active block. The hot active block stores data in a page that is determined to be a hot page. The cold active block stores data in a page that is determined to be a cold page. In the compaction active block, data in a valid page is stored through garbage collection.

If writing is performed on an active block and pages of the active block are full with data, then the control unit 121-3 transfers the active block to a data block and is allocated a new free block. When the full active block is transferred to the data block, the control unit 121-3 allocates a current block sequence number to the data block. If a hot active block or a cold active block are transferred to data blocks, the control unit 121-3 increases the block sequence number to be assigned to the data blocks by ‘1’. This is because block sequence numbers are used as time stamps to analyze data received together with a write command from the host device 110 of FIG. 1. Since written data is transferred from the flash memory 104 through garbage collection, the control unit 121-3 does not use the written data to analyze a workload. The control unit 121-3 classifies data blocks into hot data blocks, cold data blocks, or compaction data blocks by using flags.

If the number of free blocks is less than an initially set threshold number, the control unit 121-3 selects victim blocks as free blocks from among data blocks. The control unit 121-3 performs garbage collection by storing valid pages of a victim block in an active compact block.

The control unit 121-3 selects a victim block on which garbage collection is to be performed, as described below.

A hot data block that does not fall within a window is selected to be a victim block from among hot data blocks. If any hot data block does not fall within the window, a data block having the least garbage collection cost is selected to be a victim block from among other data blocks that do not fall within the window.

In a window size W, W data blocks on which writing is more recently performed are present from among data blocks that are arranged in the order in which writing is performed on the data blocks, based on block sequence numbers. Thus, blocks within a window include data blocks ranging from a data block on which writing is most recently performed to a data block disposed apart from the data block by the window size W, from among data blocks that are arranged in the order in which writing is performed on the data blocks.

Upon receiving a page write request, the control unit 121-3 determines a frequency of updating data in a logical page to be written, as described below.

In response to the page write request, the control unit 121-3 determines the logical page to be a hot page if an invalid physical page is included in a block present within a window size that is initially set based on a most recently written block, and determines the logical page to be a cold page if the invalid physical page is not included in a block present within the window size.

In response to the page write request, the control unit 121-3 determines a location of an invalid physical page to be an address of a valid physical page mapped to an address of the logical page, based on a mapping table.

In response to the page write request, the control unit 121-3 determines the logical page to be a cold page if no invalid physical page is present. The logical page is determined to be a cold page if an address of a physical page mapped to the address of the logical page is not included in the mapping table.

A method of determining a window size by using firmware installed in the control unit 121-3 will be described below.

A window size with a minimum write amplitude factor (WAF) (see Equation (4) below) may be predicted as follows.

As described above with reference to FIGS. 8A and 8B, a distribution of the number of invalid pages of each block and a garbage collection cost vary according to the characteristics of a workload. Thus, an optimum window size also varies according to the workload.

According to an example embodiment of the inventive concepts, a performance model is suggested based on a distribution of the number of invalid pages of each block, and a window size with a minimum WAF value may be detected based on the performance model.

The WAF value for a window size may be predicted using the numbers of hot pages and cold pages in blocks within the window size. Hot pages and cold pages may be detected from blocks within the window size through a two-step calculation process.

Specifically, the numbers of hot pages and cold pages in blocks within a window size W are calculated if the window size W to be predicted is greater than a currently set window size Wc and if the window size W to be predicted is less than the currently set window size Wc.

The numbers of hot pages and cold pages in blocks within the window size W if the window size W to be predicted is greater than the currently set window size Wc are calculated as described below.

If the window size W to be predicted is greater than the currently set window size Wc, no hot data block is present outside the window size W due to garbage collection.

FIG. 10 illustrates an arrangement of hot/cold data blocks excluding data blocks generated through garbage collection from among a plurality of data blocks, based on block sequence numbers, according to an example embodiment of the inventive concepts. Referring to FIG. 10, a leftmost block is a most recently written block, and a rightmost block is a least recently written block. Blocks are arranged in the order in which writing is performed thereon.

If it is assumed that a workload pattern does not sharply change, as illustrated in FIG. 10, it is expected that the number of valid pages when writing is performed on blocks ranging from a most recently written block to a block disposed apart from the most recently written block by a window size W is equal to the number of valid pages in a (W+1)th block.

Based on this expectation, the number of cold pages in all blocks within the window size W is equal to that in the (W+1)th block, and the number of hot pages in all the blocks within the window size W is equal to a result of subtracting the number of cold pages from the number of all valid pages within the window size W.

It is assumed that the number of cold pages within the window size W is CP(W), the number of hot pages within the window size W is HP(W), the number of all pages within a window is KP(W), the number of pages per block is Nb, the number of valid pages in a block disposed apart by a distance X from the left end of the data blocks illustrated in FIG. 10 is V(x), and the number of all valid pages within the window size W is Wv. Then, KP(W)=W*Nb, and Cp(W)=W*V(w+1), and HP(W)={Wv−CP(W)}.

The numbers of hot pages and cold pages in blocks within the window size W if the window size W to be predicted is less than the currently set window size Wc are calculated as described below.

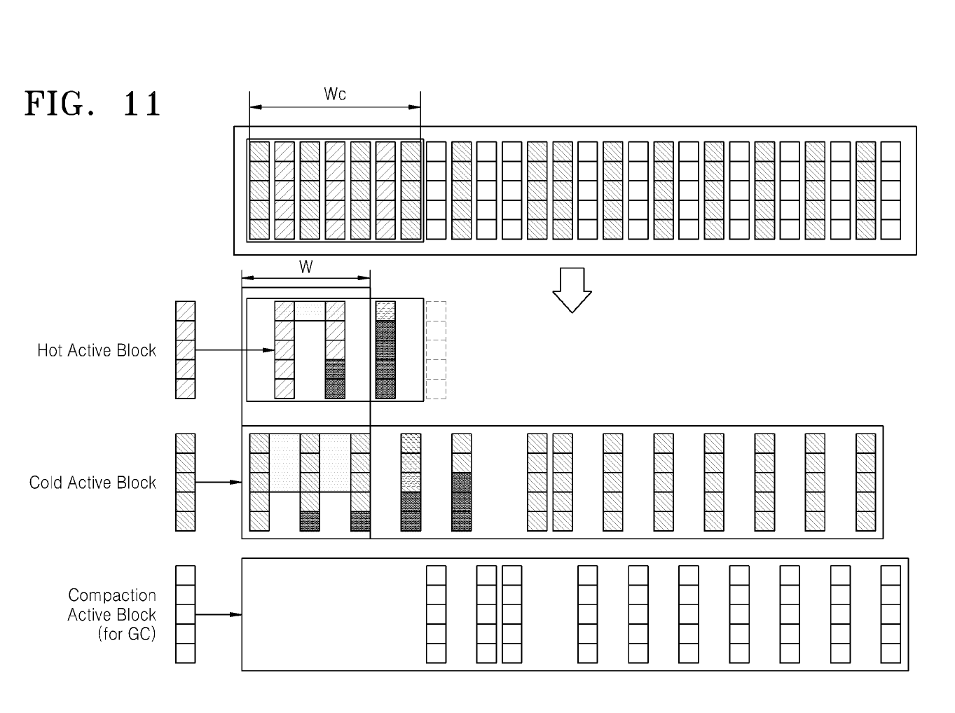

If the window size W to be predicted is less than the currently set window size Wc, the numbers of hot pages and cold pages are predicted by dividing data blocks into hot data blocks and cold data blocks, as illustrated in FIG. 11.

The number of cold pages in the hot data blocks is predicted using the number of valid pages in a first hot data block that is larger than the window size W. The number of cold pages is predicted using the number of valid pages in a first cold data block that is larger than the window size W, and then added to the number of cold pages, thereby obtaining the number of cold pages CP(W) within the window size W. The number of hot pages is calculated by subtracting the number of cold pages CP(W) from the number of all valid pages Wv within the window size W. In FIG. 11, an upper page indicated with dots from among pages of the hot data blocks denotes a valid page. Similarly, upper three pages indicated with dots from among pages of the cold data blocks denote valid pages.

As described above, the WAF value may be predicted using the numbers of hot pages and cold pages.

A hot page is stored in a hot data block and a cold page is stored in a cold data block. Thus, a total cost may be predicted by predicting costs in hot data blocks and cold data blocks, respectively multiplying the predicted costs by write rates, and adding results of the multiplication together. Each of the write rates is determined by a ratio of an amount of data to be written to a corresponding hot page to an amount of data to be written to a corresponding cold page.

Each of the amount of data to be written to the corresponding hot page and the amount of data to be written to the corresponding cold page may be calculated as described below.

If when a window size is W, K(W) denotes the number of all written pages within a window, H(W) denotes the number of written hot pages within the window, and C(W) denotes the number of written cold pages within the window, then a total predicted cost WAF may be calculated by:

$$WAF ( W ) = \frac{H ( W )}{K ( W )} \times {WAF}_{- HOT} + \frac{C ( W )}{K ( W )} \times {WAF}_{- COLD} , \qquad ( 1 )$$

wherein ‘WAF_HOT’ denotes a WAF value of a hot block, and ‘WAF_COLD’ denotes a WAF value of a cold block.

The sum of the number of written hot pages H(W) and the number of written cold pages C(W) is equal to the number of all written pages K(W). The number of all written pages K(W) is equal to a result of multiplying the numbers of pages in all blocks within the window size W together. The number of written cold pages C(W) is equal to the number of cold pages within the window, and the number of written hot pages H(W) is equal to the sum of the numbers of hot pages and invalid pages within the window. Thus, if the number of cold pages within the window is CP(W), the number of cold pages within the window is HP(W), and the number of invalid pages within the window is IP(W), then the following relation is established:

C(W)=CP(W)

H(W)=HP(W)+IP(W) (2)

An expected overprovision (a ratio of a surplus area to an entire area) of hot data blocks is ‘IP(W)/H(W)’, and an expected overprovision of cold data blocks is ‘{TIP-IP(W)}/{TP-H(W)}’. ‘TIP’ denotes the number of all invalid pages in an entire region of a flash memory, and ‘TP’ denotes the number of all physical pages in the entire region of the flash memory.

If when a window size is W, the overprovisions of hot data blocks and cold data blocks are predicted, then WAF values of the hot data blocks and the cold data blocks may be predicted. In this case, a utilization U is equal to (1-overprovision), and the relationship between an average garbage collection cost Ugc and the utilization U is as follows:

$$U = \frac{1 - Ugc}{Ln Ugc} \qquad ( 3 )$$

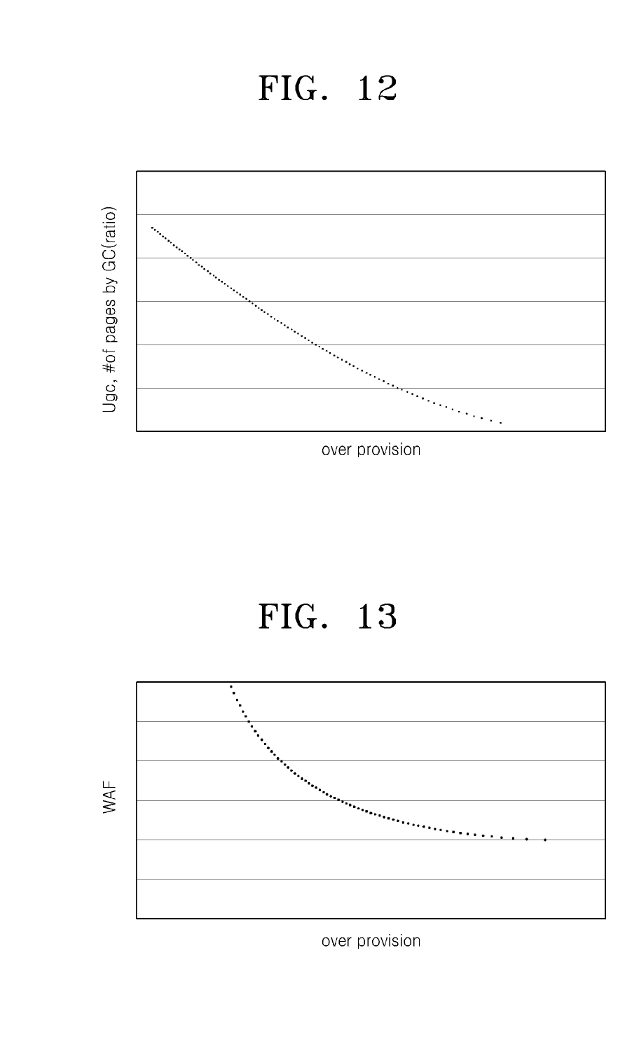

The graph of FIG. 12 may be obtained based on the utilization U=(1-overprovision). Referring to FIG. 13, as the overprovision increases, the average garbage collection cost Ugc reduces. A WAF value may be calculated from the average garbage collection cost Ugc, as follows:

$$WAF = 1 + \frac{Ugc}{1 - Ugc} \qquad ( 4 )$$

The relationship between the WAF value and the overprovision is illustrated in FIG. 13.

The window size W is proportional to the number of blocks. An optimum window size W may be determined by calculating WAF values of window sizes W in all cases WAF values and determining a window size W corresponding to the least WAF value.

If it is assumed that a workload is not sharply changed, this calculation may be performed by using the number of valid pages in a block at a point of time and a snapshot corresponding to a block sequence number, if a write request is received. An optimum window size W may be experimentally set by simply searching for some of the total number of blocks.

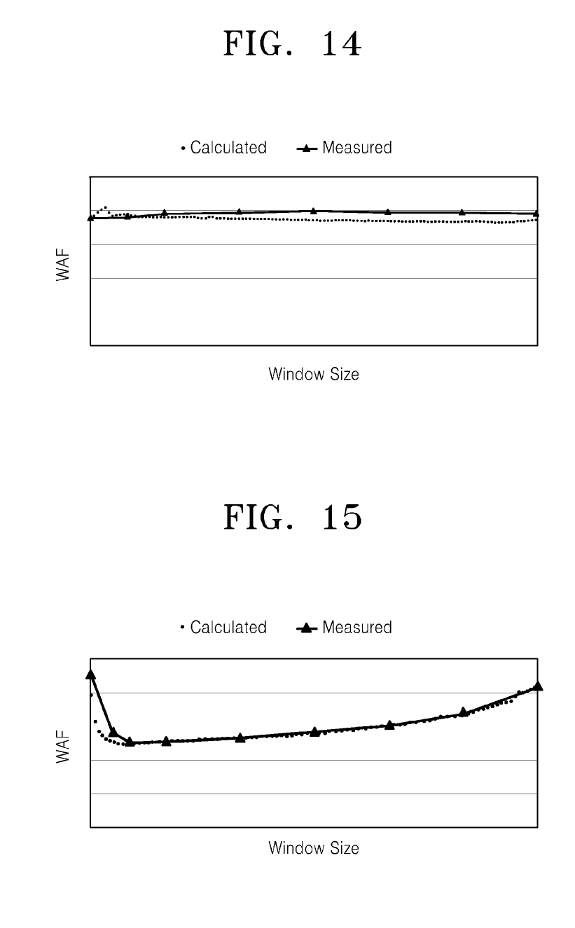

FIG. 14 is a graph comparing WAF values calculated with respect to random data by using a model according to a window size according to an example embodiment of the inventive concepts with WAF values that were actually measured. Referring to FIG. 14, the measured WAF values are substantially the same as the calculated WAF values, and are about 2.0 regardless of a window size.

If a ratio between amounts of hot writing and cold writing is 1:2 and a workload is an A type workload with a hot data region of 7 MB (1/200), a graph comparing WAF values calculated using a model according to an example embodiment of the inventive concepts with WAF values that were actually measured is illustrated in FIG. 15.

Referring to FIG. 15, both the measured WAF values and the calculated WAF values are smallest when a window size W=50. A WAF gain is about 40% greater than when the window size W=0.

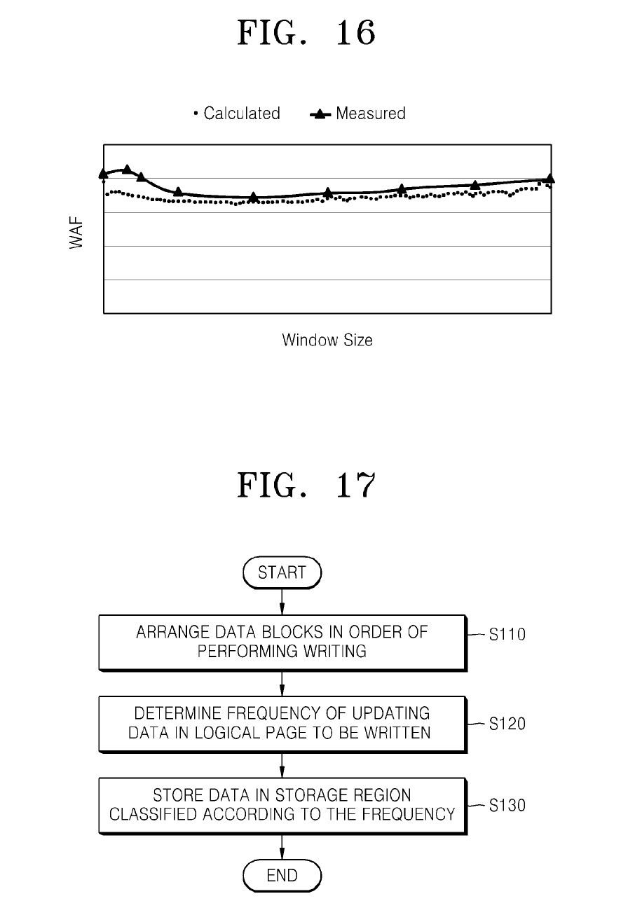

If a ratio between amounts of hot writing and cold writing is 2:1 and a workload is a B type workload with a hot data region of 4 MB (1/100), a graph comparing WAF values calculated using a model according to an example embodiment of the inventive concepts with those that were actually measured is illustrated in FIG. 16.

Referring to FIG. 16, both the measured WAF values and the calculated WAF values are smallest when a window size W=100. Since an amount of hot writing in the case of the type B workload is smaller than that in the case of the type A workload, a WAF gain obtained through hot/cold page separation is lower than that in the graph of FIG. 15.

A method of managing a storage region of a memory device according to an example embodiment of the inventive concepts will now be described with reference to FIG. 17. The method of FIG. 17 may be performed under control of the control unit 121-3 of FIG. 3.

The control unit 121-3 arranges data blocks according to an order of writing (operation S110). Referring to FIG. 9, if data is written to an active block and pages of the active blocks are full with the data, the control unit 121-3 transfers the active block to a data block and allocates a current block sequence number to the data block. If a hot active block or a cold active block are transferred to data blocks, the block sequence number is increased by ‘1’. Likewise, a block sequence number may be allocated to a data block. Data blocks may be arranged based on the order of writing by arranging the data blocks according to block sequence numbers.

The control unit 121-3 determines a frequency of updating data in a logical page to be written (operation S120). In response to a write request, the control unit 121-3 determines the logical page to be a hot page if an invalid physical page is present in a block within a window size that is initially set based on a most recently written block, and determines the logical page to be a cold page if the invalid physical page is not present in a block within the initially set window size. If it is determined that no physical page is invalid, the logical page is determined to be a cold page. The logical page is determined to be a cold page if an address of a physical page mapped to the address of the logical page to be written is not present in a mapping table.

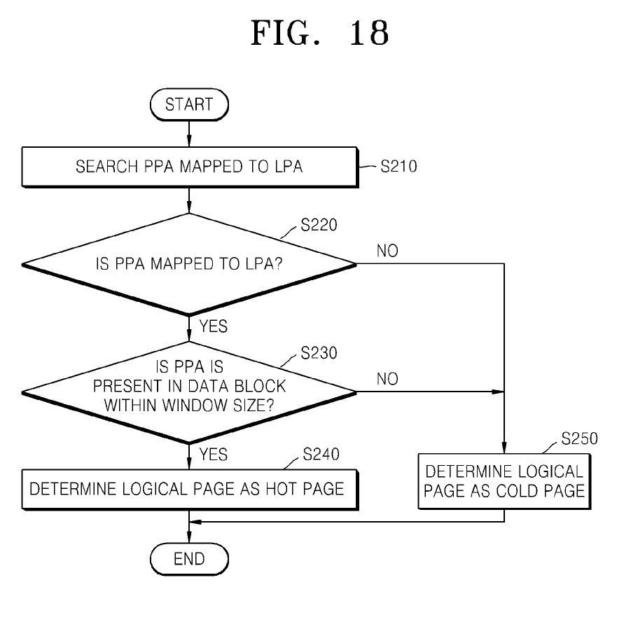

FIG. 18 is a detailed flowchart of operation S120 included in the method of FIG. 17, according to an example embodiment of the inventive concepts. Referring to FIGS. 3 and 18, the control unit 121-3 searches a mapping table stored in the RAM 121-2 for an address of a physical page mapped to an address of a logical page to be written (operation S210). An address of an invalid physical page is searched for in response to a write request. A logical page address (LPA) may also be referred to as a logical page number (LPN), and a physical page address (PPA) may also be referred to as a physical page number (PPN).

The control unit 121-3 determines whether in operation S210, an address of a physical page mapped to the address of the logical page is present in the mapping table (operation S220).

If it is determined in operation S220 that an address of a physical page mapped to the address of the logical page is present in the mapping table, then the control unit 121-3 determines whether the address of the physical page is present in a data block within a window size W that is initially set based on a most recently written block from among data blocks arranged based on block sequence numbers (operation S230). It is determined whether an invalid physical page is present in a data block within the window size W, according to a write request. The window size W may be set to an initial value according to the characteristics of a workload, as described above.

If it is determined in operation S230 that the address of the physical page is present in a data block within the window size W, the control unit 121-3 determines the logical page is a hot page (operation S240).

If it is determined in operation S230 that the address of the physical page is not present in the mapping table or if it is determined in operation S230 that the address of the physical page is not present in a data block within the window size W, the control unit 121-3 determines the logical page is a cold page (operation S250).

In operation S120, a frequency of updating data in the logical page may be determined as described above.

Referring back to FIG. 17, after operation S120 is performed, the control unit 121-3 stores the data in the logical page to be written in a storage region of the memory device categorized according to the frequency determined in operation S120 (operation S130).

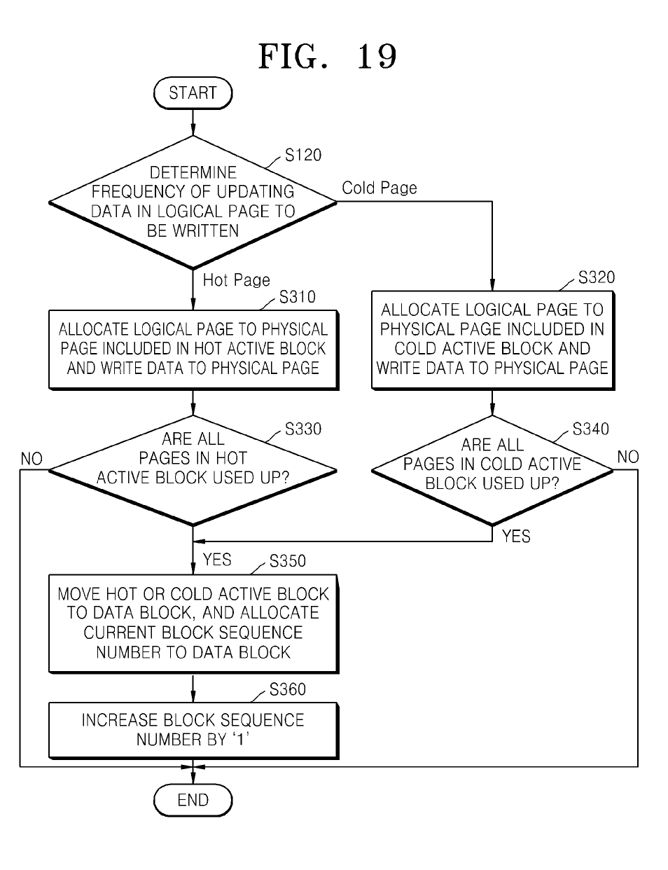

FIG. 19 is a detailed flowchart of operation S130 included in the method of FIG. 17, according to an example embodiment of the inventive concepts. Referring to FIG. 19, if the logical page is determined to be a hot page according to the determination in operation S120, the control unit 121-3 controls the storage apparatus 120 to allocate the logical page to a physical page included in a hot active block and write the data in the logical page to the physical page (operation S310).

If the logical page is determined to be a cold page according to the determination in operation S120, the control unit 121-3 controls the storage apparatus 120 to allocate the logical page to a physical page included in a cold active block and write the data in the logical page to the physical page (operation S320).

The control unit 121-3 determines whether all pages in the hot active block are used up (operation S330). It determines whether all the pages in the hot active block are mapped to the logical page and are full with data.

The control unit 121-3 determines whether all pages in the cold active block are used up (operation S340). It determines whether all the pages in the cold active block are mapped to the logical page and are full with data.

If it is determined in operation S330 or operation S340 that all the pages in the hot/cold active block are used up, the hot active block or the cold active block is transferred to a data block, and a current block sequence number is allocated to the data block (operation S350).

The control unit 121-3 increases the current block sequence number by ‘1’ (operation S360).

If it is determined in operation S330 or operation S340 that all the pages in the hot/cold active block are not used up, the method is ended.

Operation S130 included in the method of FIG. 17 may be performed as described above.

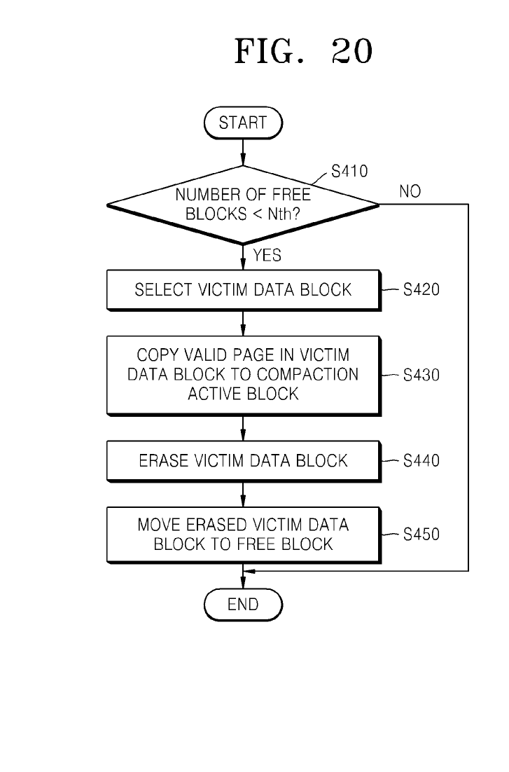

FIG. 20 is a flowchart illustrating a method of performing garbage collection, according to an example embodiment of the inventive concepts. The method of FIG. 20 may be performed under control of the control unit 121-3 illustrated in FIG. 3.

The control unit 121-3 determines whether the number of free blocks is less than an initially set threshold value Nth (operation S410).

If it is determined in operation S410 that the number of free blocks is less than the initially set threshold value Nth, then the control unit 121-3 selects a victim block from among data blocks (operation S420).

Operation S420 is illustrated in detail in FIG. 21. Referring to FIG. 21, the control unit 121-3 determines whether a hot data block that does not fall within a window is present from among the data blocks (operation S510).

If it is determined in operation S510 that a hot data block that does not fall within the window is present from among the data blocks, the control unit 121-3 selects the hot data block to be a victim block (operation S520).

If it is determined in operation S510 that a hot data block that does not fall within the window is not present from among the data blocks, the control unit 121-3 selects a data block with a least garbage collection cost from among other data blocks that do not fall within the window, to be a victim block (operation S530). A data block having a largest number of invalid pages from among the data blocks that do not fall within the window is selected to be a victim data block on which garbage collection is to be performed.

A victim data block may be selected as described above.

Referring back to FIG. 20, after operation S420 is performed, the control unit 121-3 copies a valid page in the victim data block to a blank page of a compaction active block (operation S430).

Then, the control unit 121-3 performs erasing on the victim data block (operation S440).

The control unit 121-3 moves the erased victim data block to a free block (operation S450).

Garbage collection may be performed as described above.

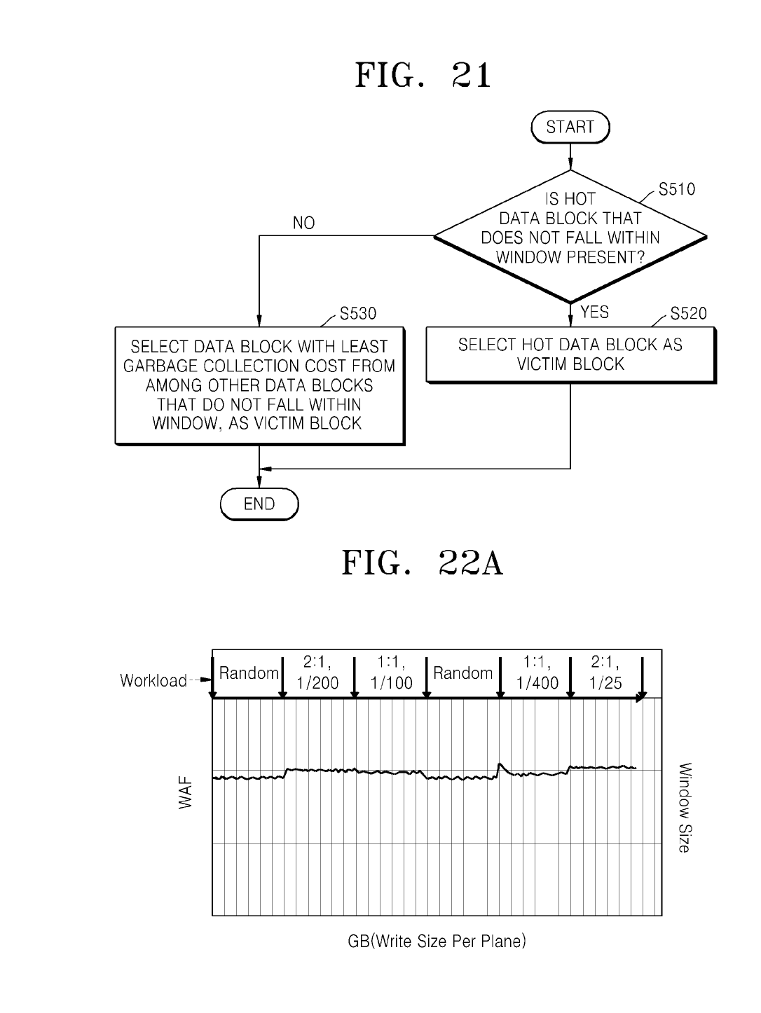

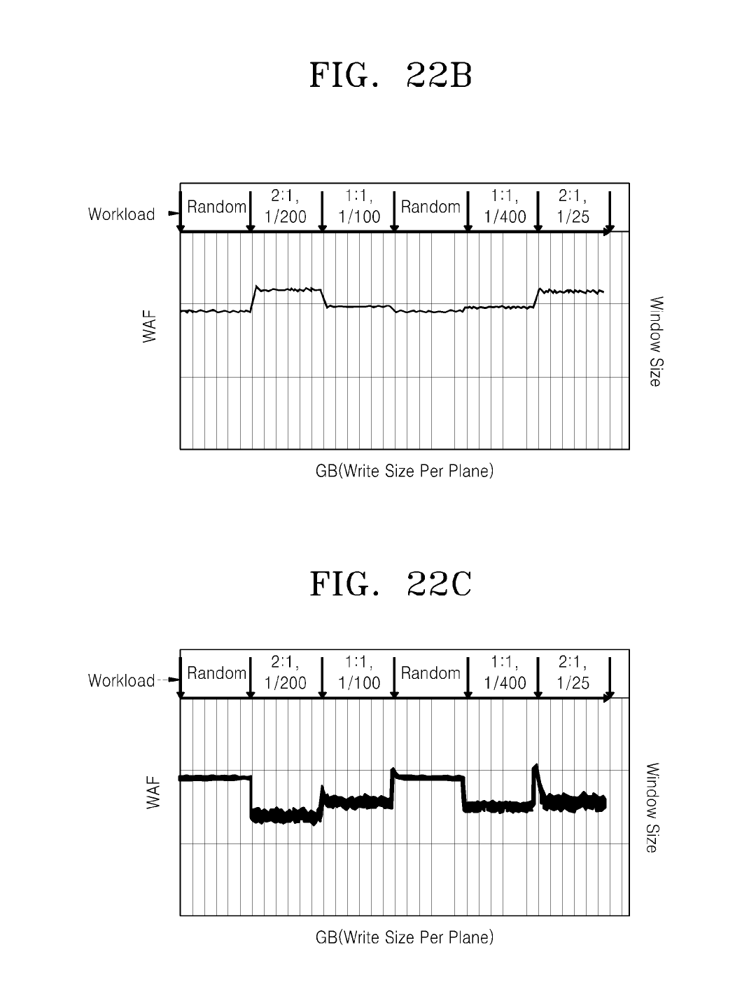

A WAF value if a method according to an example embodiment of the inventive concepts is performed and a WAF value if dynamic data clustering (DAC) is performed are illustrated in FIGS. 22A to 22C.

FIG. 22A is a graph showing WAF values calculated by applying a DAC-Level 4 method to various workloads. FIG. 22B is a graph showing WAF values calculated by applying a DAC-Level 2 method to various workloads. FIG. 22C is a graph showing WAF values calculated by applying hot/cold page separation to various workloads.

A DAC method may be used to determine a logic page to be written as a hot or cold page. A DAC method based on an N-level frequency is referred to as a DAC-Level N method. Whether updating is performed within a desired (or, alternately, a predetermined) time period is determined. A hot level is increased by one level when a given logical page is updated within a reference time period (a time threshold), and is maintained constant when the given logical page is updated after the reference time period. If garbage collection occurs, a hot level of a valid logical page in a victim block is reduced by one level if the valid logical page is updated after the reference time period, and is maintained constant if the valid logical page is updated before the reference time period. In the DAC method, a time stamp is used for each page to determine whether a time period has passed.

An input workload may be expressed as (a ratio of an amount of hot data to be written to an amount of cold data to be written, the size of a hot data region). If the input workload is set to be ‘(random), (2:1, 1/200), (1:1, 1/100), (random), (1:1, 1/400), (2:1, 1/25)’, WAF values calculated using a model according to an example embodiment of the inventive concepts are illustrated in FIG. 22C, WAF values calculated using the DAC-Level 4 method are illustrated in FIG. 22A, and WAF values calculated using the DAC-Level 2 method are illustrated in FIG. 22B.

Referring to FIGS. 22A to 22C, a WAF gain obtained using the model according to an example embodiment of the inventive concepts is about 40% less than when the DAC-Level 2 method is used.

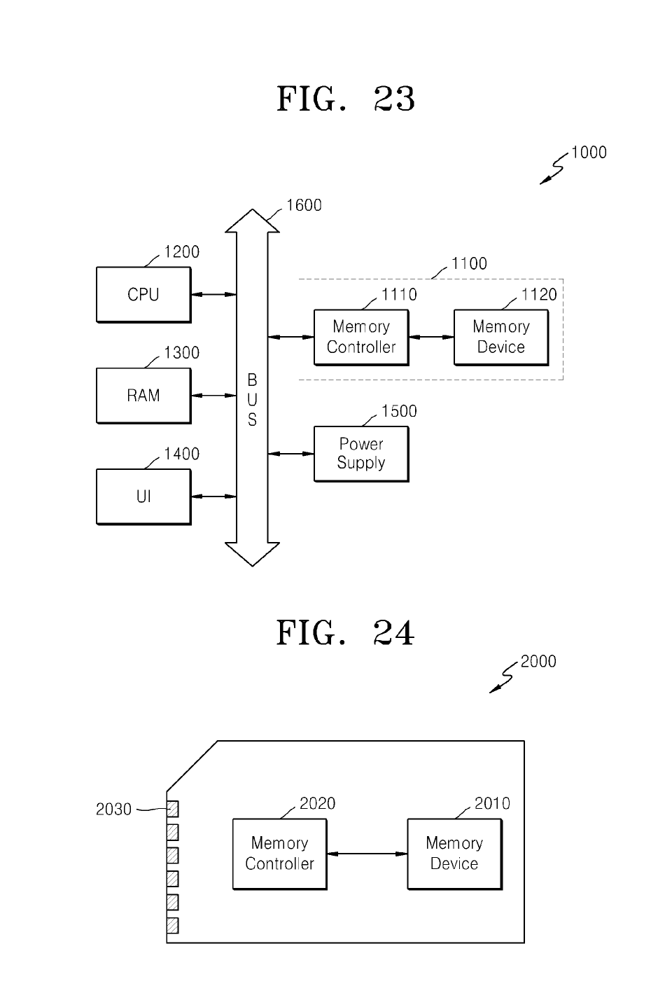

FIG. 23 is a block diagram of a computer system 1000 according to an example embodiment of the inventive concepts. The computer system 1000 includes a central processing unit (CPU) 1200, a random access memory (RAM) 1300, a user interface (UI) 1400, and a memory apparatus 1100 that are electrically connected via a bus 1600. The memory apparatus 1100 includes a memory controller 1110 and a memory device 1120. Data, which was processed or is to be processed by the CPU 1200, is stored in the memory device 1120 via the memory controller 1110. The memory apparatus 1100 may be the same as the memory apparatus 120 of FIG. 1 according to an example embodiment of the inventive concepts. The computer system 1000 may further include a power supply device 1500.

If the memory system 1000 is a mobile device, the power supply device 1500 may be a battery, and a modem, such as a baseband chipset, may be additionally provided. It will be obvious to those of ordinary skill in the art that the computer system 1000 may further include an application chipset, a camera image processor (CIS), mobile dynamic random access memory (DRAM), and the like.

FIG. 24 is a block diagram of a memory card 2000 according to an example embodiment of the inventive concepts. Referring to FIG. 24, the memory card 2000 includes a memory controller 2020 and a memory device 2010. The memory controller 2020 controls data to be written to or read from the memory device 2010, in response to a request received from an external host (not shown) via an input/output (I/O) unit 2030. Although not shown, in order to control the writing and the reading, the memory controller 2020 of the memory card 2000 may further include, for example, an interface unit that performs an interface with the external host and a RAM that performs an interface with the memory device 2010. The memory card 2000 may be embodied as the memory apparatus 120 of FIG. 1.

The memory card 2000 may be embodied as a compact flash card (CFC), a micro-drive, a smart media card (SMC), a multimedia card (MMC), a security digital card (SDC), a memory stick, a universal serial bus (USB) flash memory driver, or the like.

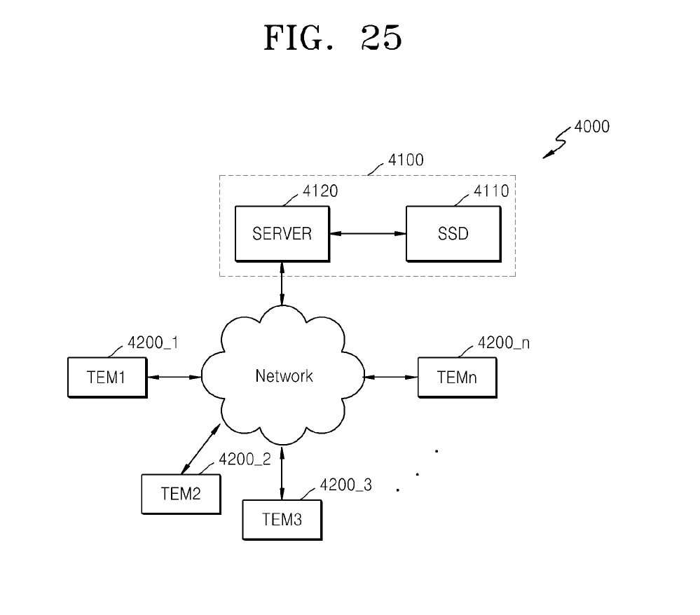

FIG. 25 is a block diagram of a network system 4000 that includes a data storage system, according to an example embodiment of the inventive concepts. Referring to FIG. 25, the network system 4000 may include a server system 4100 and a plurality of terminals 4200_1 to 4200_n that are connected via a network. The server system 4100 may include a server 4120 that processes requests from the plurality of terminals 4200_1 to 4200_n connected via the network, and a solid-state drive (SSD) 4110 that stores data corresponding to the requests. In this case, the SSD 4110 may be the same as the memory apparatus 120 of FIG. 1.

A flash memory system according to the above one or more example embodiments may be mounted by using any of various types of packages, for example, package on package (PoP), ball grid arrays (BGAs), chip scale packages (CSPs), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flatpack (TQFP), a small outline IC (SOIC), a shrink small outline package (SSOP), a thin small outline (TSOP), a thin quad flatpack (TQFP), a system in package (SIP), a multi chip package (MCP), a wafer-level fabricated package (WFP), and a wafer-level processed stack package (WSP).

While example embodiments of the inventive concepts have been particularly shown and described with reference to example embodiments thereof, it will be understood that various changes in form and details may be made therein without departing from the spirit and scope of the following claims.

What is claimed is:

1. A method of managing a storage region of a memory device, the method comprising:
arranging data blocks in an order of performing writing on the memory device;
determining a frequency of updating data in a logical page to be written in response to a write request, the determining being based on whether an invalid physical page is present in a block within a window size, the window size being initially set based on a most recently written data block from among the arranged data blocks; and
storing the data in the logical page in a storage region of the memory device classified according to the determined frequency.

2. The method of claim 1, further comprising:
determining a location of the invalid physical page to be an address of a valid physical page mapped to an address of the logical page to be written.

3. The method of claim 1, further comprising:
classifying the logical page as a cold page if no invalid physical page is present, in response to the write request.

4. The method of claim 1, further comprising:
classifying the logical page to be written as a hot page if an invalid physical page is present in a data block within the window size and as a cold page if an invalid physical page is not present in a data block within the window size.

5. The method of claim 4, wherein the storing comprises:
allocating the logical page determined to be the hot page to a physical page included in an active block that is set as a hot active block, and the logical page determined to be the cold page to a physical page included in an active block that is set as a cold active block.

6. The method of claim 5, wherein the storing comprises:
moving the active block to a data block if data is completely stored in all pages included in the active block that is set as the hot active block or the cold active block.

7. The method of claim 6, wherein the storing comprises:
increasing a block sequence number allocated to the data block by ‘1’ if the hot active block or the cold active block is moved to a data block.

8. The method of claim 7, wherein the arranging step arranges data blocks in the order of performing writing on the memory device, based on the block sequence number.

9. The method of claim 1, wherein the arranging step excludes data blocks generated through garbage collection from the data blocks.

10. The method of claim 1, wherein the window size varies according to workload characteristics.

11. The method of claim 1, wherein the determining step determines the window size to be a window size that is expected to have a least write cost, based on a write cost calculated based on a number of invalid pages in the data blocks arranged in the order of performing writing.

12. The method of claim 1, further comprising:
selecting, if a hot data block that does not fall within the window size is present, the hot data block to be a victim data block to perform garbage collection, and
selecting a data block having a largest number of invalid pages from among data blocks that do not fall within the window to be a victim data block to perform garbage collection if a hot data block that does not fall within the window size is not present.

13. A storage apparatus comprising:
a memory device configured to store data; and
a memory controller configured to generate block sequence information based on an order of performing writing on the memory device, configured to determine a frequency of updating data in a logical page to be written based on the block sequence information and mapping table information, the determining being based on whether an address of a valid physical page mapped to an address of the logical page is present in a block within a window size, the window size being initially set based on a most recently written block from among data blocks arranged based on the block sequence information, and the memory controller configured to allocate a physical page address to the logical page.

14. The storage apparatus of claim 13, wherein the memory controller comprises:
a volatile memory device configured to temporarily store the block sequence information and the mapping table information; and
a control unit configured to determine the logical page to be a hot page if an address of a physical page mapped to the address of the logical page is present in a block within the window size, configured to determine the logical page to be a cold page if an address of a physical page mapped to the address of the logical page is not present in a block within the window size, based on the mapping table information and the block sequence information, and configured to control page writing by separating a hot page storage region and a cold page storage region from each other.

15. The storage apparatus of claim 14, wherein the control unit includes firmware configured to perform garbage collection by determining a hot data block that does not fall within the window size to be a victim data block if the hot data block is present and determining a data block having a least garbage collection cost from among data blocks that do not fall within the window size, to be a victim data block if the hot data block is not present.

16. A method of managing data blocks in a memory device, the method comprising:
storing data from a logical page in a first type of data block if an address of the logical page is mapped to an address of a physical page in a data block determined to be in a window size W, the window size W based on a most recently written data block from among data blocks arranged based on block sequence numbers; and
storing the data from the logical page in a second type of data block if one of (1) the address of the logical page is not mapped to an address of a physical page and (2) the address of the logical page is mapped to an address of a physical page in a data block outside the window size W.

17. The method of claim 16, wherein the window size is set to have a least write cost, based on a write cost calculated based on a number of invalid pages in the data blocks arranged in the order of performing writing.

18. The method of claim 16, further comprising:
selecting, if a hot data block that does not fall within the window size is present, the hot data block to be a victim data block to perform garbage collection, and
selecting a data block having a largest number of invalid pages from among data blocks that do not fall within the window size to be a victim data block to perform garbage collection if a hot data block that does not fall within the window size is not present.
